(19) United States
(12) Patent Application Publication
(10) Pub. No.: US 2025/0273031 A1
(43) Pub. Date: Aug. 28, 2025

(54) COIN SORTING AND STORAGE DEVICE

(71) Applicant: SHENZHEN GLAMORTECH INDUSTRIAL CO., LTD, Shenzhen (CN)

(72) Inventor: Pengbo MU, Shenzhen (CN)

(21) Appl. No.: 18/986,723

(22) Filed: Dec. 19, 2024

(30) Foreign Application Priority Data
Feb. 22, 2024 (CN) 202420329097.X

(51) Int. Cl. G07D 9/06; B60R 7/08

(52) U.S. Cl. CPC G07D 9/06; B60R 7/087

(57) ABSTRACT

The present application discloses a coin sorting and storage device, which comprises a storage device body, an elastic component and a coin holder, wherein the storage device body is provided therein with a coin storage cavity with an open end; the elastic component is arranged inside the coin storage cavity; the coin holder is arranged at the open end of the coin storage cavity; the open end is provided with a shielding part and a taking-out part, the shielding part can shield the open end partially so that coins are partially blocked after they are put into the coin storage cavity, and the taking-out part is a part of the open end that is not shielded by the shielding part and is used by a user to take out the coins.

### TECHNICAL FIELD

The present application belongs to the technical field of vehicles, in particular to a coin sorting and storage device for vehicles.

### BACKGROUND ART

With the continuous development of the economy, cars have become the most common means of transport for the families. At least one cup holder is arranged inside a car for holding water bottles. However, in actual daily life, the cup holder is rarely used to hold water bottles; instead, it is often used to hold some sundries, especially small changes. Although the cup holder can hold small changes if the small changes are directly put in the cup holder, the small changes will be stored in a messy state and it will be difficult to take out a required amount of small changes; in addition, it will be very troublesome to empty the cup holder to hold water bottles.

The existing coin storage boxes only allow storing coins from the top and taking out the coins from the bottom. Therefore, they are very inconvenient for drivers to store or take out coins during driving, or they do not have appropriate size or shape and cannot be well fixed in cars for convenient use.

### SUMMARY OF THE INVENTION

The examples of the present application provide a coin sorting and storing device, which can sort and store coins of different sizes when a driver wants to store or take out coins at any time during driving, and has improved convenience and practicability as coins can be stored and taken out at any time, while ordinary coin boxes can't meet the requirement. It is more convenient for the user to take out the coins while realizing a coin storage function.

The examples of the present application provide a coin sorting and storage device, comprising a storage device body, an elastic component and a coin holder, wherein the storage device body is provided with a coin storage cavity with an open end, the elastic component is arranged inside the coin storage cavity, and the coin holder is arranged at the open end of the coin storage cavity, wherein
the open end is provided with a shielding part and a taking-out part, wherein the shielding part can shield the open end partially so that coins are partially blocked after they are put into the coin storage cavity; the taking-out part is a part of the open end that is not shielded by the shielding part, and is used for a user to take out the coins.

Optionally, the storage device body is provided with at least one coin storage cavity therein.

Optionally, the open end is provided with a coin chute, which extends in a direction inconsistent with the direction of extension of the coin storage cavity.

Optionally, the storage device body is provided with at least two coin storage cavities therein, and the open end of each coin storage cavity is provided with a coin chute.

Optionally, the coin chutes are at different levels.
Optionally, the coin chutes extend in different directions.

Optionally, the cross-sectional diameters of the coin storage cavities are different from each other.

Optionally, the coin chute corresponding to the coin storage cavity having a greater cross-sectional diameter is at a level higher than that of the coin chute corresponding to the coin storage cavity having smaller cross-sectional area.

Optionally, the coin storage cavity is provided with a coin holder chute therein, and the coin holder comprises a coin holder sliding part that is slidably connected to the coin holder chute.

Optionally, the undeformed elastic component has a length greater than the length of the coin storage cavity and contacts with the coin holder in the coin storage cavity.

In the examples of the present application, a coin sorting and storage device that can be arranged in the cup holder of the armrest box at the central control console of a vehicle is employed, and, with a technical scheme that employs an elastic component, the coins stored in the coin sorting and storage device are kept in a taking-out part, so that the coins are always visible to the user and can be taken out by the user. Thus, coins of different sizes can be sorted and stored, and can be taken out at any time, and the convenience and practicability are improved. It is more convenient for the user to take out the coins while realizing a coin storage function.

### BRIEF DESCRIPTION OF THE DRAWINGS

The technical scheme of the present application and its beneficial effects will become apparent in the following detailed description of specific embodiments of the present application with reference to the accompanying drawings.

FIG. 1 is a schematic structural diagram of a coin sorting and storage device provided in an example of the present application;

FIG. 2 is an exploded structural view of the coin sorting and storage device in FIG. 1;

FIG. 3 is a schematic diagram of an upper housing structure provided in an example of the present application;

FIG. 4 is a bottom view of the upper housing structure in FIG. 3;

FIG. 5 is a schematic structural diagram of a coin holder provided in an example of the present application;

FIG. 6 is a schematic structural diagram of an elastic structure provided in an example of the present application; and

FIG. 7 is a schematic structural diagram of a lower housing provided in an example of the present application.

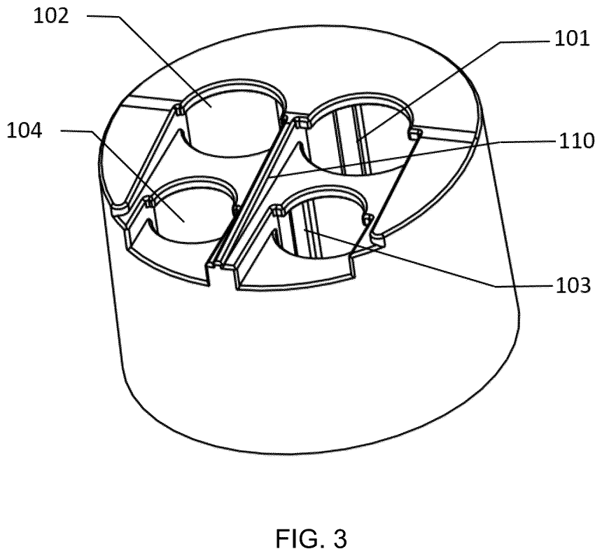

FIGS. 3 to 7 are structural diagrams of parts. In the reference numerals in these figures, the first digit is the part number, while the latter two digits are the structural distinguishing number of the part.

### REFERENCE NUMERALS

1—upper housing; 101—first coin holder chute; 102—first coin storage cavity of the upper housing; 103—second coin holder chute; 104—second coin storage cavity of the upper housing; 105—first connecting hole; 110—coin chute;
2—first coin holder; 201—coin holder sliding part;
3—second coin holder;
4—third coin holder;
5—fourth coin holder;
6—first elastic component; 604—end of first elastic component;
7—second elastic component;
8—third elastic component;
9—lower housing; 901—first coin storage cavity of the lower housing; 902—second coin storage cavity of the lower housing; 903—third coin storage cavity of the lower housing; 904—fourth coin storage cavity of the lower housing; 905—second connecting hole

### EMBODIMENTS

The technical scheme in the examples of the present application will be described below clearly and completely with reference to the accompanying drawings in the examples of the present application. Apparently, the examples described herein are only some possible examples of the present application rather than all possible examples of the present application. Based on the examples provided herein and without expending any creative labor, those skilled in the art can obtain all other examples which also fall in the scope of protection of the present application.

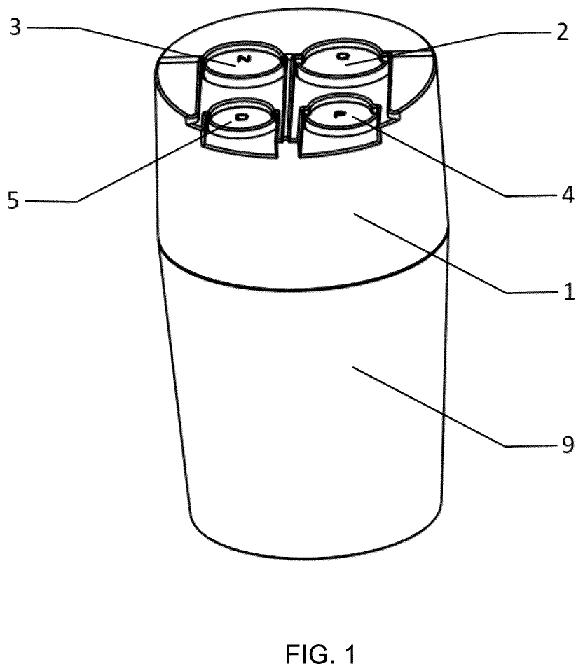

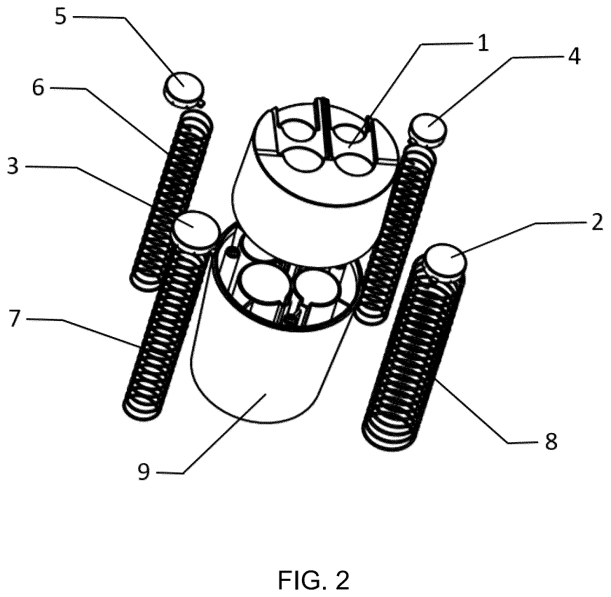

Please see FIGS. 1-2. FIG. 1 is a schematic structural diagram of a coin sorting and storage device provided in an example of the present application, FIG. 2 is an exploded structural view of the coin sorting and storage device in FIG. 1. This example of the present application provides a coin sorting and storage device, in particular a coin sorting and storage device used in the cup holder of the armrest box at the central control of a vehicle. In some alternative embodiments, the coin sorting and storage device provided in the example of the present application comprises an upper housing 1, a lower housing 9, four coin holders 2, 3, 4, 5, and an elastic component, wherein the upper housing 1 and the lower housing 9 are fixedly connected with each other to form a storage device body, and four coin storage cavities having one open end are arranged in the storage device body, and each coin storage cavity is provided with an elastic component therein, one end of the elastic component is in contact with the lower housing 9, and the other end of the elastic component is in contact with the coin holder.

Furthermore, the coin holder is arranged at the open end of the coin storage cavity;

Furthermore, the open end is provided with a shielding part and a taking-out part; after the user deposits coins into the coin sorting and storage device through the taking-out part, the shielding part can shield the open end partially so that the coins are partially blocked after they are put into the coin storage cavity; and the taking-out part is a part of the open end that is not shielded by the shielding part, and is used for the user to take out the coins.

It can be understood that the open end may be circular, and essentially consistent with the shape of the coin; the shielding part may be a shielding part extending uniformly along the edge of the open end to the center of circle of the open end, that is to say, the width of the shielding part in the radial direction of the open end is consistent; alternatively, the shielding part may be in any other shape, and extends along the edge of the open end to the center of circle of the open end; for example, the shielding part may be formed by a plurality of semi-ellipses, a plurality of rounded triangles, a plurality of waves or their combinations.

Furthermore, a part of the open end that is not shielded by the shielding part forms the taking-out part. The user's fingers can touch the coins stored in the coin sorting and storage device through the taking-out part, so that the coins can be taken out from the taking-out part for use.

It can be understood that the storage device body may be an integrally formed part or a part composed of a plurality of components (e.g., an upper housing, a middle housing, and a lower housing or more components). There is no particular restriction on the structure of the storage device body.

In some alternative embodiments, the storage device body is provided with at least one coin storage cavity therein; in some other alternative embodiments, the storage device body is provided with at least two coin storage cavities therein, so that different sorts of coins can be stored separately.

Please see FIGS. 2 and 3 further. FIG. 3 is a schematic structural diagram of an upper housing provided in an example of the present application. By arranging a coin chute at the open end of each coin storage cavity, it is convenient for the user to take out the coins from the coin storage cavity having the shielding part.

In some alternative examples, the width of the coin chute 110 is approximately equal to the diameter of the open end, one end of the coin chute 110 is connected to the open end, and the other end of the coin chute 110 extends to an outer edge of the coin sorting and storage device, so as to ensure that coins can slide out of the open end along the coin chute 110 when the user takes out the coins for use.

In some alternative embodiments, the coin chute 110 extends in the radial direction of the open end, and the extension direction of the coin storage cavity is perpendicular to the extension direction of the coin chute 110.

Please see FIG. 3. In some alternative embodiments, the coin sorting and storage device comprises two groups of coin storage cavities, and each group includes two coin storage cavities. For example, in a group of coin storage cavities, each coin storage cavity is provided with a coin chute, and the coin chutes are at different levels. The level can be the height of the coin storage cavity in the extension direction.

Furthermore, the coin chutes in the same group extend in the same direction, so as to effectively save the space;

Still furthermore, the cross-sectional diameters of the coin storage cavities in the same group may be different from each other, and the diameters of the corresponding coin chutes may be different from each other;

It can be understood that the cross-sectional diameters of different groups of coin storage cavities may be different, and the diameters of corresponding coin chutes may be different;

It can also be understood that the cross-sectional diameters of different groups of coin storage cavities may be the same partially, and the diameters of the corresponding coin chutes may be the same;

Still furthermore, in the case that the cross-sectional diameters of the coin storage cavities in the same group are different from each other, the coin chute corresponding to the coin storage cavity having a greater cross-sectional diameter is at a level higher than that of the coin chute corresponding to the coin storage cavity having smaller cross-sectional area, so that the user can deposit and take out coins of different sizes without mutual interference.

It can be understood: in the case that a group of coin storage cavities include more coin storage cavities, the coin storage cavities are arranged from top to bottom in a descending order of cross-sectional area, so that the user can deposit and take out coins of different sizes conveniently without mutual interference.

Please see FIGS. 3, 5 and 6. In some alternative embodiments, each coin storage cavity is provided with a coin holder chute, and each coin holder comprises a coin holder sliding part 201, which is slidably connected to the coin holder chute.

In some alternative embodiments, each coin storage cavity is provided with more than one coin holder chute, and correspondingly, each coin holder is provided with a corresponding number of coin holder sliding parts, which can ensure the stability and reliability of the coin holder during sliding.

In some alternative embodiments, each coin storage cavity is provided with an elastic component therein, the length of the undeformed elastic component is greater than that of the coin storage cavity and the elastic component contacts with the coin holder in the coin storage cavity, so as to ensure that the coins stored on the coin holder can be kept at the open end and can be taken out by the user conveniently. In addition, when the user takes out the topmost coin, the adjacent coins will be automatically sent to the open end, so that the user can takes out the coins again conveniently.

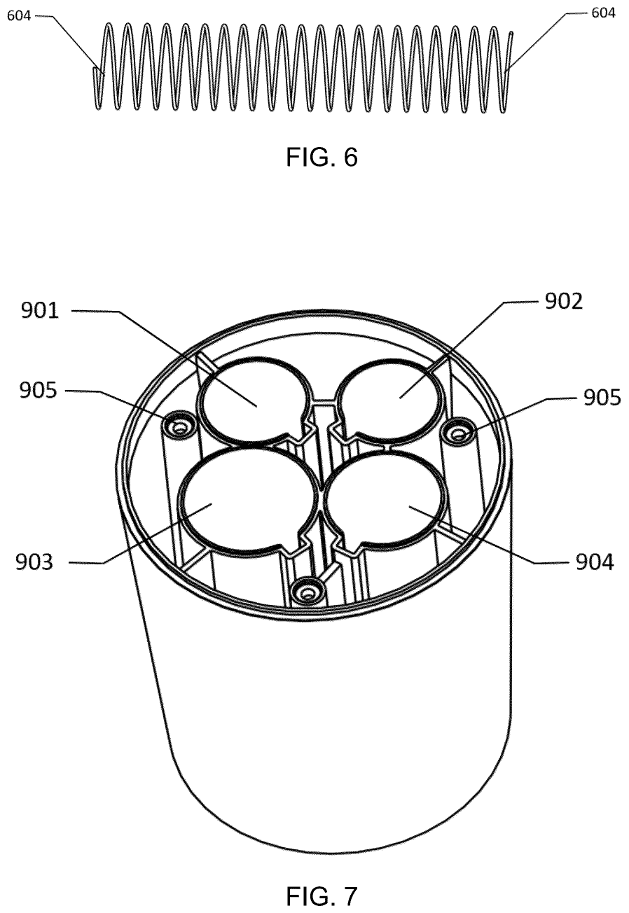

In some alternative embodiments, for example, the elastic component may be a first elastic component spring shown in FIG. 6. The end 604 of the first elastic component is in contact with the coin holder and the lower housing respectively.

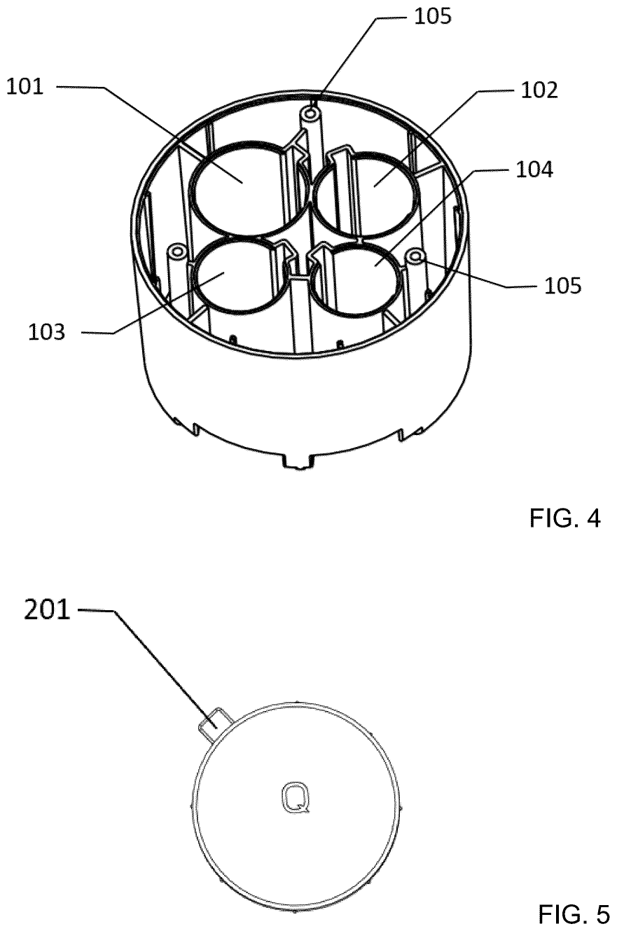

Please see FIGS. 4 and 7. The upper housing 1 is provided with at least one first connecting hole 105. The lower housing 9 is correspondingly provided with at least one second connecting hole 905. The upper housing 1 and the lower housing 9 may be fixedly connected by screw joint, rivet joint or any other common structure for fixed connection.

In some alternative embodiments, the upper housing 1 is provided with a first coin storage cavity 102, a second coin storage cavity 104, a third coin storage cavity (not shown in the figure) and a fourth coin storage cavity (not shown in the figure); accordingly, the lower housing 9 is provided with a second coin storage cavity 902 of the lower housing, a fourth coin storage cavity 904 of the lower housing, a first coin storage cavity 901 (not shown in the figure) of the lower housing and a third coin storage cavity 903 of the lower housing. After the first connecting hole 105 and the second connecting hole 905 are aligned and fixedly connected, the corresponding coin storage cavities of the upper housing and the lower housing are also aligned to form a coin storage cavity in the storage device body.

It can be understood that the coin sorting and storage device may comprise one group or more than two groups of coin storage cavities, and each group of coin storage cavities may comprise at least two coin storage cavities.

In some alternative embodiments, the outer surface of the lower housing 9 is provided with a flexible protective sheath (not shown in the figure), which can increase the elasticity when the user puts the coin sorting and storage device into the cup holder of the armrest box at the central control of the vehicle, and make the installation more flexible and reliable. The flexible protective sheath may be directly formed as the outer surface of the lower housing 9, for example, it may be directly bonded to the lower housing 9 to form an integral structure; or the flexible protective sheath may be a separate flexible protective sheath, for example, made of a silicone material, a rubber material or other common flexible materials.

In the above examples, the description of each example has its own emphasis. For the parts not detailed in one example, please refer to the relevant descriptions of other examples.

While the coil sorting and storage device provided in the examples of the present application are described in detail above and the principle and embodiments of the present application are described in detail by utilizing specific cases, the explanation of those examples are only used to facilitate understanding the method and core idea of the present application; those having ordinary skills in the art can make modifications to the specific embodiments and their scope of application on the basis of the idea of the present application.

In summary, the content of this specification shall not be understood as constituting any limitation on the present application.

1. A coin sorting and storage device, comprising a storage device body, an elastic component and a coin holder, wherein the storage device body is provided therein with a coin storage cavity with an open end; the elastic component is arranged inside the coin storage cavity; the coin holder is arranged at the open end of the coin storage cavity; the open end is provided with a shielding part and a taking-out part, the shielding part can shield the open end partially so that coins are partially blocked after they are put into the coin storage cavity, and the taking-out part is a part of the open end that is not shielded by the shielding part and is used by a user to take out the coins, characterized in that, the storage device body has a first coin storage cavity and a second coin storage cavity therein, an open end of the first coin storage cavity is provided with a first coin chute, an open end of the second coin storage cavity is provided with a second coin chute, and the first coin chute is at a level higher than that of the second coin chute.

2. The coin sorting and storage device according to claim 1, characterized in that both the first coin chute and the second coin chute extend radially along the open end.

3. The coin sorting and storage device according to claim 2, characterized in that a projection of the second coin chute in the vertical direction is fully within a projection of the first coin chute in the vertical direction.

4. The coin sorting and storage device according to claim 1, characterized in that the width of the first coin chute is greater than the width of the second coin chute.

5. The coin sorting and storage device according to claim 1, characterized in that the diameter of the open end of the first coin storage cavity is approximately equal to the width of the first coin chute, and the diameter of the open end of the second coin storage cavity is approximately equal to the width of the second coin chute.

6. The coin sorting and storage device according to claim 1, characterized in that the first coin chute extends from the open end of the first coin storage cavity to an outer edge of the coin sorting and storage device, and the second coin chute extends from the open end of the second coin storage cavity to the outer edge of the coin sorting and storage device.

7. The coin sorting and storage device according to claim 6, characterized in that the first coin chute and the second coin chute terminate at approximately the same position on the outer edge of the coin sorting and storage device.

8. The coin sorting and storage device according to claim 6, characterized in that the length of the first coin chute is greater than that of the second coin chute.

9. The coin sorting and storage device according to claim 1, characterized in that the coin storage cavity is provided with a coin holder chute therein, and the coin holder comprises a coin holder sliding part that is slidably connected to the coin holder chute.

10. The coin sorting and storage device according to claim 1, characterized in that the length of undormed elastic structure is greater than the length of the coin storage cavity and the elastic structure contacts with the coin holder in the coin storage cavity.

11. A coin sorting and storage device, comprising a storage device body, an elastic component and a coin holder, wherein the storage device body is provided with a coin storage cavity with an open end, the elastic component is arranged inside the coin storage cavity, and the coin holder is arranged at the open end of the coin storage cavity, characterized in that,
the open end is provided with a shielding part and a taking-out part, wherein the shielding part can shield the open end partially so that coins are partially blocked after they are put into the coin storage cavity; the taking-out part is a part of the open end that is not shielded by the shielding part, and is used for a user to take out the coins.
